(19) United States
(12) Patent Application Publication
(10) Pub. No.: US 2005/0246056 A1
(43) Pub. Date: Nov. 3, 2005

(54) Materials handling system

(76) Inventors: Peter Geoffrey Marks, Moama (AU); Gavin Ivor Alder, Echuca (AU); Murray Alan Grant, Echuca (AU); David William Langford, Chelsea (AU)

Correspondence Address: Harold V. Stotland;Seyfarth Shaw LLP, Suite 4200, 55 East Monroe Street, Chicago, IL, 60603-5803, US

(21) Appl. No.: 10/892,786

(22) Filed: Jul. 16, 2004

(30) Foreign Application Priority Data
Apr. 23, 2004 (AU) 2004201709

(51) Int. Cl. G06F 7/00

(52) U.S. Cl. 700/213

(57) ABSTRACT

The present invention relates to a package arranging system for arranging a plurality of package sets into a predetermined configuration. The package sets occupy respective ones of a plurality of second positions in the predetermined configuration. A positioning means is provided for positioning, when required, the package sets at respective ones of a plurality of first positions on a first transportation means. The first transportation means transports the package sets from the first positions along a plurality of first paths. A restraining means is provided for restraining the transport of the package sets along the first paths so that the package sets accumulate on the first transportation means at the second positions. The package sets are thereby collectively arranged into the predetermined configuration. A method for arranging the package sets and a simulation method for allowing a user to simulate the arranging of the package sets is also provided.

### FIELD OF THE INVENTION

The present invention relates to a materials handling system for the packaging industry. In particular, the present invention relates to a materials handling system for use in the food and beverage industry when handling packages of containers of food, beverages and the like. One aspect of the invention relates to a package arranging system for arranging a plurality of package sets into a predetermined configuration. The present invention also relates to a method for arranging the package sets and a simulation method for allowing a user to simulate the arranging of the package sets. Another aspect of the present invention relates to the use of mechanical means such as, for example, cantilever arms or the like, particularly in the form of robots and/or robotic systems to arrange packages in a predetermined order.

### BACKGROUND OF INVENTION

Materials handling systems are used in food and beverage processing plants. Specialized packaging machines are used for bundling a number of separate food or drink containers together to form a single, often substantially rectangular package of such containers. An example of such a package is a “slab” or carton of beer comprising twenty-four individual beer cans. The package is then delivered on a conveyor from which factory workers remove each package, one package at a time, and place it upon a portable pallet to form a pallet stack. Pallets come in standard sizes and the choice of pallet size used in a particular factory or packaging line is often dependent upon a number of factors including the size of the individual containers and packages, and the type of fork lift used to transport them. Once the pallet stack is completed, the stack is secured on the pallet and the pallet is subsequently transported to a truck using the fork lift or similar.

A first horizontal layer of packages is formed when packages are placed at predetermined positions on the pallet. After the first layer is completed, a second layer can be subsequently assembled upon the first layer. The second layer generally has a different predetermined configuration of packages compared with the first layer, thereby reducing the possibility of the pallet stack collapsing during assembly or transport. A pallet stack comprising a number of different horizontal layers of various arrangements is formed on the pallet in this manner, with each alternating layer having a different configuration of packages to adjacent layers.

The foregoing manual pallet and layer assembly processes are very labour intensive. Automated materials handling systems have been introduced into the food and beverage processing industry for manipulating individual packages to form pallet layers on a conveyor, however, are relatively rudimentary in nature. Line dividers are used to separate packages laterally on the conveyor during transportation. The packages are subsequently rotated (i.e. oriented) on the conveyor using bump rotators, which push (or bump) against the side of the packages thereby causing them to rotate about a point of contact. Alternative deflection-type devices can be also be used to orient packages.

These divide-and-rotate systems are quite inflexible being difficult to setup initially, and subsequently to further modify when, for example, the types of packages to be handled are subject to change from time to time. In addition, the reliability of these handling systems is prone to variation owing to the difficulty in accurately positioning and orienting the packages at various stages during transport on the conveyor. That is, the position and orientation of each package is subject to considerable variation over time which adversely affects the reliability of pallet layer assembly.

Multiple trial runs must be performed when setting up these automated systems. This is undesirable. The speed of automated pallet stack construction is also limited since each package must be handled one at a time, and whilst factory workers provide greater flexibility in this respect, simultaneously carrying multiple packages undesirably results in factory workers handling increasingly heavier payloads. The efficiency of factory workers is also affected by the physical reach limitations of the workers when picking and placing the packages. In this respect, divide-and-rotate systems are superior because the distance between picking and placing positions is lesser.

The present invention relates to a mechanical system which provides a more flexible alternative for forming a pallet stack than automation techniques currently used in the food and beverage processing industry. The mechanical system also provides more accurate and/or consistent placement of packages during pallet layer assembly.

### SUMMARY OF INVENTION

According to one aspect of the present invention, there is provided a package arranging system for arranging a plurality of package sets into a predetermined configuration comprising:
positioning means for, when required, fixedly gripping respective ones of said package sets and subsequently positioning said package sets at respective ones of a plurality of first positions and first orientations on a first transportation means;
said first transportation means for transporting said package sets from said first positions toward corresponding ones of a plurality of second positions along a plurality of first paths; and
restraining means for restraining the transport of said package sets along said first paths so that said package sets accumulate on said first transportation means at said second positions, said package sets thereby being collectively arranged into said predetermined configuration when said package sets are in said second positions.

Preferably, said positioning means comprises a robot coupled to a gripper for fixedly gripping said first package sets during positioning.

Preferably, said gripper comprises a first grasping member and a second grasping member, both grasping members, in use, being contracted together for grasping a package set on opposing sides, said package set thereby being gripped in compression by said grasping members.

Even more preferably, said positioning means comprises a cantilever arm robot and a gripper, said positioning means, in use, operating as a pick-and-place robotic system.

Preferably, said positioning means can position said package sets in said first positions with a positional accuracy of less than about ±15 mm, preferably less than about ±10 mm, more preferably from less than about ±3 to ±10 mm, and most preferably less than about ±6 mm.

Preferably, each package set has a second orientation when positioned at a corresponding second position, each respective first orientation being based on a corresponding one of said second orientations.

Preferably, when required, said package sets are fixedly gripped at respective ones of a plurality of third positions on respective ones of a plurality of second paths on said first transportation means and subsequently positioned by sliding said package sets on said first transportation means to corresponding ones of said first positions.

Preferably, said first paths are linear.

Preferably, said package sets are consecutively transported to said positioning means in a known sequence.

Preferably, said package sets are substantially identical and have a uniform size, shape and weight.

Alternatively, a first package set is of a first size and a second package set is of a second size.

Preferably, each package set is a singleton set comprising one package only.

Alternatively, a package set comprises at least two packages.

According to a further aspect of the present invention, there is provided a simulation method for allowing a user to simulate the arranging of a plurality of package sets into a predetermined configuration, said method comprising the steps of:
simulating the positioning of said package sets at respective ones of a plurality of first positions;
simulating the transport of said package sets from said first positions toward corresponding ones of a plurality of second positions along a plurality of first paths; and
simulating the restraint of the transport of said package sets along said first paths so that said package sets accumulate at said second positions, said package sets thereby being collectively arranged into said predetermined configuration when said package sets are in respective ones of a plurality of second positions.

Preferably, said second positions of each respective package set are input by said user to a computer system performing said simulation.

Preferably, said determined first positions can be translated to a controller for controlling the package arranging system.

Preferably, first orientations can also be translated to the controller for controlling the package arranging system.

According to a further aspect of the present invention, there is provided a method for arranging a plurality of package sets into a predetermined configuration comprising the steps of:
when required, fixedly gripping respective ones of said package sets and subsequently positioning said package sets at respective ones of a plurality of first positions and first orientations on a first transportation means;
transporting said package sets by said first transportation means from said first positions toward corresponding ones of a plurality of second positions along a plurality of first paths; and
restraining the transport of said package sets along said first paths so that said package sets accumulate on said first transportation means at said second positions, said package sets thereby being collectively arranged into said predetermined configuration when said package sets are in said second positions.

Preferably, said package sets are gripped by a gripper coupled to a cantilever arm robot, said gripper and cantilever arm robot combining to position said package sets in said first positions with a positional accuracy of less than about ±15 mm.

Preferably, said gripper and cantilever arm robot combine to position said package sets in said first positions with an orientation accuracy of less than about ±2°.

Preferably, the method for arranging a plurality of package sets comprises, prior to arranging said plurality of package sets into said predetermined configuration, the steps of:
computer simulating the arrangement of said plurality of packages into said predetermined configuration using a package arranging system; and
translating simulation parameters used during said computer simulation to a controller for controlling said package arranging system.

Preferably, said simulation parameters translated include said first positions and first orientations for each respective package set at a corresponding first position.

### BRIEF DESCRIPTION OF DRAWINGS

A preferred embodiment of the invention will now be described, by way of example, in relation to the accompanying drawings, wherein:

FIG. 1a. is a schematic side elevation view of a package arranging system according to a first embodiment of the present invention;

FIG. 1b. is a schematic plan view of the package arranging system of FIG. 1a;

FIG. 2 is a schematic plan view showing, at four successive moments in time (i.e. t=1, 2, 3 and 4), a method for arranging a plurality of package sets into a predetermined configuration according to a second example of the first embodiment;

FIG. 3 is a perspective view of one form of a gripper suitable for use with a package arranging system according to the present invention; and

FIG. 4a is a schematic side elevation view of a package arranging system according to a second embodiment of the present invention;

FIG. 4b. is a schematic plan view of the package arranging system of FIG. 4a;

### DESCRIPTION OF PREFERRED EMBODIMENT

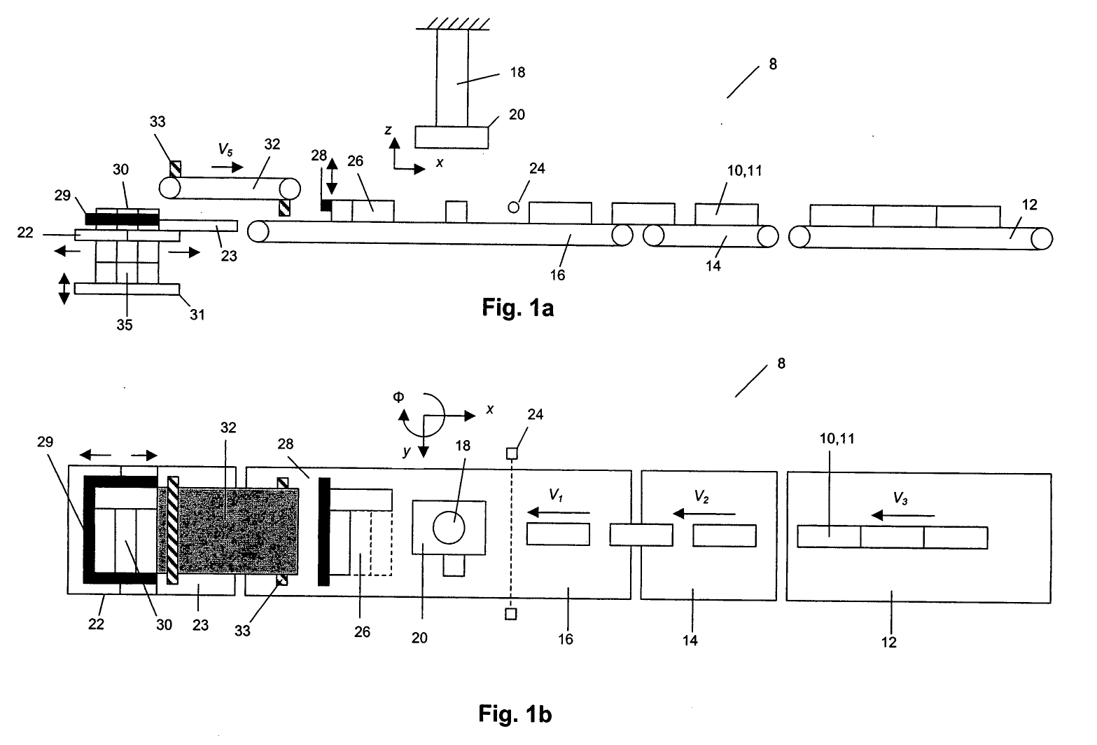

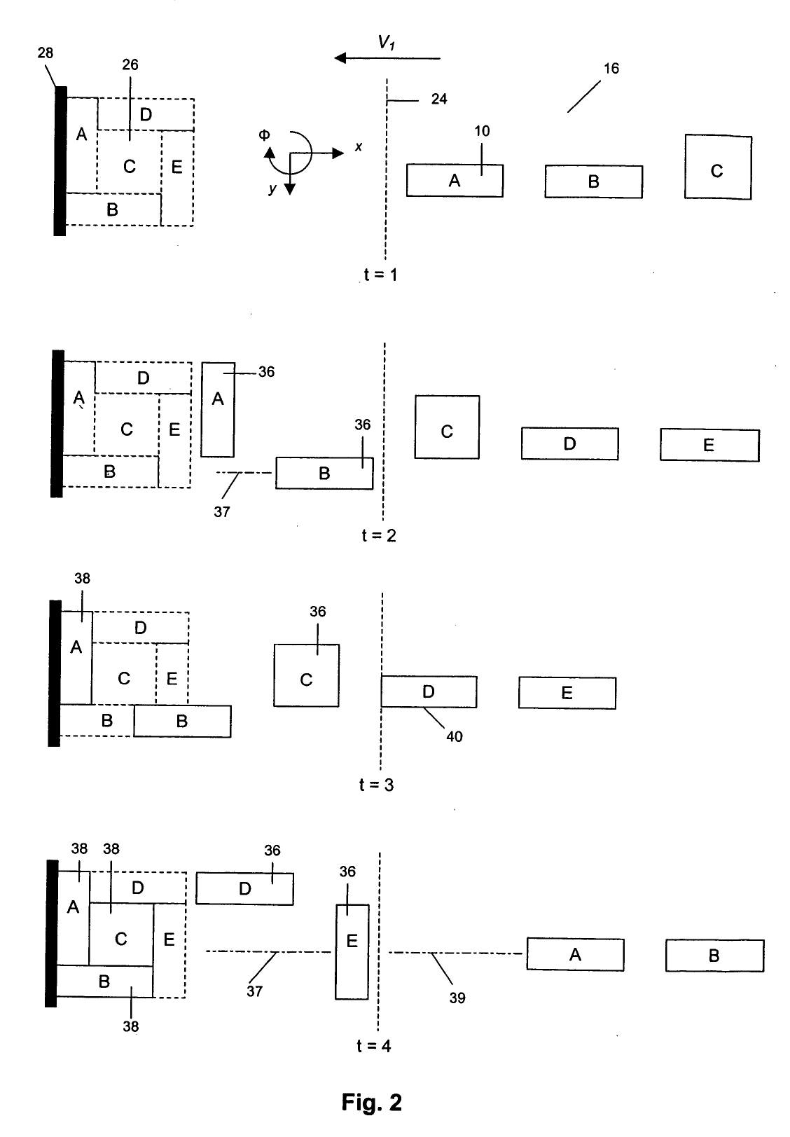

According to a first embodiment of the present invention, there is provided a package arranging system 8 as shown in FIGS. 1 and 2. The package arranging system 8 can be used for arranging a plurality of package sets 11 into a predetermined configuration 26 (shown as a dashed outline in FIG. 1b) of package sets 11 to form a layer 30 for a pallet 31. Each package set 11 is a singleton set comprising a single package 10 only. The predetermined configuration 26 is formed when the packages 10 are in required layer positions 38 (also referred to as second positions 38). Once formed, each predetermined configuration 26 is transported as a single unit, or in unison, to the pallet 31 thereby forming a layer 30 on the pallet 31. A typical example of a package set 11 is a single carton of 24 bottles or cans of a beverage such as, for example, beer or the like.

The package arranging system 8 comprises a metering station where packages 10 are provided to the system, a separating station for separating adjacent packages 10 thereby introducing required distances of separation between adjacent packages 10, and an arranging station for arranging the packages 10 into the predetermined configuration 26. Accordingly, a first transportation means is provided which comprises a metering conveyor 12 (also referred to as the third conveyor 12), a separating station conveyor 14 (also referred to as the second conveyor 14) and an arranging station conveyor 16 (also referred to as the first conveyor 16).

The conveyors 12, 14, 16 are all belt conveyors which are aligned linearly and separated from each other by a marginal gap. However, packages 10 initially resting on the metering (third) conveyor 12 can be transported through to the arranging station (first) conveyor 16. Thus, the first transportation means transports each package 10 from the metering (third) conveyor 12 to a corresponding layer (second) position 38 located on the arranging station (first) conveyor 16 (FIG. 2).

A detailed description of the package arranging system 8 shown in FIG. 1 is provided below.

A package infeed system is provided for the package arranging system 8 by way of a metering (third) conveyor 12 upon which a number of packages 10 rest. The packages 10 can be provided to the metering (third) conveyor 12 by a factory worker. Alternatively, the packages 10 can be provided to the metering (third) conveyor 12 by a specialized packaging machine; either directly, or indirectly using an intermediate conveyor (not shown).

The packages 10 are arranged lineally and preferably “nose to tail” (i.e. metered). The ends of each package 10 may or may not abut any adjacent packages 10. The packages 10 on the metering (third) conveyor 12 are transported along their respective input paths 39 (also referred to as second paths 39) at a metering velocity V₃ (also referred to as the third velocity) of between 12 to 18 metres per minute (m/min).

Each package 10 is transferred, in succession, from the metering (third) conveyor 12 to the separating station (second) conveyor 14. The separating station (second) conveyor 14 forms the basis of the separating station which increases the separation between consecutive packages 10 being transported by a certain pre-selected distance. That is, the separation between adjacent packages 10, in the direction of transport along their input (second) paths 39, is increased. The separation of packages 10 in this manner improves the reliability and ease with which packages 10 can be handled at a subsequent stage of transportation. The separating station (second) conveyor 14 transports the packages 10 at a separating velocity V₂ (also referred to as the second velocity) of 50 m/min. Hence, the separating (second) velocity V₂ is greater that the metering (third) velocity V₃ and therefore the packages 10 are further separated when they are transferred from the metering (third) conveyor 12 to the separating station (second) conveyor 14.

The separated packages 10 are then transferred to an arranging station (first) conveyor 16 where they are transported at an arranging velocity V₁ (also referred to as the first velocity) of 50 m/min. Hence, the arranging (first) velocity V₁ is comparable to the separating (second) velocity V₂ of the separating station (second) conveyor 14, and thus the separation introduced between successive packages 10 by the separating station (second) conveyor 14 is maintained by the arranging station (first) conveyor 16.

Ideally, the position of a package 10 transferred to the arranging station (first) conveyor 16 should be co-linear with its previous positions on both the separating station (second) conveyor 14 and metering (third) conveyor 12. That is, each package 10 maintains a substantially constant y-axis coordinate (using Cartesian coordinates to describe the position of each package 10 in the xy-plane) when being transported up until this point. As shown in FIG. 1, the x-axis corresponds to the longitudinal axis of the conveyors 12, 14, 16 and the y-axis corresponds to the normal axis of the conveyors 12, 14, 16. The position of each package 10 denotes the centroid of each package in the xy-plane and is co-incident with a corresponding path.

A first beam sensor 24 is used to detect each package 10 when it reaches a fixed x-axis coordinate. The first beam sensor 24 is typically a send-receive, photo electric eye, narrow beam type which generates an electrical trigger signal when the optical beam (dashed line in FIG. 1b) is broken by a package 10 as it travels along the x-axis. The beam is horizontal and parallel to the arranging station (first) conveyor 16 upon which the packages 10 are transported. The first beam sensor 24 is further positioned so that the beam crosses the arranging station (first) conveyor 16 in the y-axis at a height (in the z-axis which is perpendicular to the xy-plane) below the top of each package being transported. Hence, each package 10, in succession, breaks the beam and generates the electrical trigger signal.

When a package 10 generates the beam trigger signal, both the x-axis and y-axis coordinates of the package 10 are known. This position forms a picking position 40 (also referred to as the third position 40) on the input (second) path 39 of the package 10 (FIG. 2). When a package 10 is detected by the first beam sensor 24 at a picking (third) position 40, positioning means in the form of a robotic system can be used to position the package 10 t a placing position 36 (also referred to as a first position 36). The positioning means is a first pick-and-place robotic system, which is similar to those conventionally used in materials handling systems, and comprises a first robot 18 coupled to a first gripper 20. The first gripper 20 is used for fixedly gripping the packages 10 during positioning. The first robot 18 is a cantilever arm robot with its base firmly fixed above the center (in the y-axis) of the arranging station (first) conveyor 16. In particular, the first robot 18 is a ABB IRB 2400/16 cantilever arm robot, which is a typical “off-the-shelf” industrial robot, and can handle a maximum payload of 16kg during pick-and-place operations. The first gripper 20 which grips the packages 10 during positioning weights approximately 10 kg. Therefore, the first pick-and-place robotic system can reliably move packages 10 weighing up to 6 kg from picking (third) positions 40 to placing (first) positions 36 using conventional pick-and-place techniques.

The belt of the arranging station (first) conveyor 16 is plastic and thereby has a low coefficient of friction. Packages heavier than 6 kg, and up to 15 kg, can be reliably transported from picking (third) positions 40 to placing (first) positions 36 using the first pick-and-place robotic system, by sliding each package from its picking (third) position 40 to a desired placing (first) position 36. Typically, the packages would also have a low co-efficient of friction on their sliding surface, and the distance between picking (third) 40 and placing (first) 36 positions would be small. Therefore, a smaller, and consequently cheaper first robot 18 can be used for sliding each package 10 across the arranging station (first) conveyor 16 when handling heavier packages 10 in this manner. The first gripper 20 must firmly grip each package 10 when using this positioning technique, because any slip in the package position relative to the first gripper 20 is highly undesirable. It is desirable that the position of the package 10 being gripped by the gripper be accurately known, thus allowing packages to be placed in their required placing (first) positions 36 with a positional accuracy of at least about ±15 mm and a placing orientation Φ (also referred to as a first orientation) accuracy of at least about ±2°.

The first pick-and-place robotic system orients, when required, each package 10 in a placing (first) orientation v when positioning each package 10 at a desired placing (first) position 36. The first gripper 20 is therefore used to orient each package 10 in the xy-plane accordingly. Hence, the pick-and-place robotic system of the present embodiment is able to position and orient packages both accurately and simultaneously, whereas, alternative systems of the prior art generally provide two-step positioning and orienting operations, and are less flexible and less accurate.

After positioning a package 10 at a placing (first) position (x,y) with a placing (first) orientation (f), the package 10 travels along an arranging path 37 (also referred to as a first path 37) to a corresponding layer (second) position 38 (x,y) where it has a layer orientation Φ (also referred to as a second orientation). In the present embodiment, a package 10 having a placing (first) orientation Φ at a placing (first) position 36 maintains this orientation during transport along the arranging (first) path 37 to the layer (second) position 38. That is, the placing (first) orientations and layer (second) orientations for each package 10 are the same and, therefore, each placing (first) orientation is based on a corresponding layer (second) orientation for a given package 10 being transported along an arranging (first) path 37. The orientations Φ can be measured relative to any arbitrary point in the xy-plane including the arranging (first) paths 37.

A barrier 28 is provided as one example or type of restraining means for restraining the transport of the packages 10 along their corresponding arranging (first) paths 37, so that the packages 10 accumulate on the arranging station (first) conveyor 16 at their required layer (second) positions 38. In use, the barrier 28 is a fixed horizontal bar which is parallel to the carrying surface of the arranging station (first) conveyor 16, and spans across the arranging station (first) conveyor 16 at a height (in the z-axis) which is less than the top of the packages being transported along their arranging (first) paths 37. The predetermined configuration 26 abuts the barrier 28.

FIG. 1 shows a first example, at a moment in time, where the first two packages 10 of a predetermined configuration 26 have accumulated abutting the barrier 28 at their required layer (second) positions 38 and orientations A. These two packages abut the barrier 28 which prevents them from being transported by the arranging station (first) conveyor 16. The belt of the arranging station (first) conveyor 16, having a low coefficient of friction, slides under these two packages 10 at the arranging (first) velocity V₁ whilst the packages 10 remain in their fixed layer (second) positions 38. The packages 10 remain in their fixed layer (second) positions 38 (x,y) owing to the flat edges of the packages which abut the barrier 28. The packages 10 may be subject to some jitter, however, the layer (second) positions 38 of the packages 10 remain substantially fixed relative to one another.

Generally, there is a y-axis separation between packages 10 in their layer (second) positions 38. This separation is factored in when positioning each package 10 at a placing (first) position 36 and accounts for the placing (first) positioning inaccuracies of up to about ±15 mm and the placing (first) orientation accuracy of up to about ±2°. The purpose of this separation is to ensure that a first package 10, being transported along an arranging (first) path 37, does not interfere with a second package 10 already in a layer (second) position 38.

The two remaining packages 10 which are yet to occupy the predetermined configuration 26 in FIG. 1 must be shifted in orientation by 90° when being positioned at their placing (first) positions 36. These packages 10 will then accumulate at their respective layer (second) positions 38 on the arranging station (first) conveyor 16 and hence the packages 10 will be collectively arranged into the predetermined configuration 26.

The completed predetermined configuration 26 of four packages 10 forms a layer 30 of packages 10 to be transported to a pallet 31. There is substantially no separation in the x-axis between adjacent packages forming the layer 30. Once the layer 30 is formed, the barrier 28 is lifted (i.e. in the z-axis) thereby allowing the layer 30 to be transported by the arranging station (first) conveyor 16, before being transferred from the arranging station (first) conveyor 16 to a pair of retractable plates 22.

A second transportation means is provided for transporting the assembled layer 30 from the first transportation means to the pallet 31. The second transportation means comprises a static plate 23, a first flight bar system, a receiving means 29, and the pair of retractable plates 22. The first flight bar system is provided for pushing the layer 30 from the arranging station (first) conveyor 16 onto the pair of retractable plates 22. The first flight bar system comprises two flight bars 33 which are attached to the chain or belt of a first flight bar conveyor 32, although, in other embodiments there may be additional flight bars 33. The separation of the flight bars 33 on the flight bar conveyor 32 is based upon the size of the layer 30 such that each successive flight bar 33 is synchronised to push a successive layer 30.

The first flight bar conveyor 32 transports the flight bars 33 at a flight bar (fifth) velocity V₅ of 50 m/min, which is comparable to the metering (first) velocity V₁. Hence, a flight bar 33 pushes against the layer 30, which slows as it reaches the static plate 23, and further transfers the layer 30 over the static plate 23 and onto the pair of sunken retractable plates 22. The layer 30 is thus pushed along the x-axis in conjunction with the layer 30 being initially transported by the arranging station (first) conveyor 16. The first flight bar system further slides the layer 30 across the pair of retractable plates 22 such that the layer 30 is received by the receiving means 29 which acts as another barrier. The layer 30 is therefore confined in the xy-plane by the “U” shaped receiving means 29 and the edge of the static plate 23 when resting on the pair of retractable plates 22.

The pallet 31 is moveable along the z-axis and has a pallet stack 35, comprising two layers 30, resting upon it at the moment in time shown in FIG. 1. The pallet 31 is positioned in the z-axis such that the top of the pallet stack 35 is proximate to the bottom of the pair of retractable plates 22. The retractable plates 22 are made from rigid metal sheet having a relatively low coefficient of friction, and are able to retract apart and contract together in the x-axis.

The receiving means 29 combines with the edge of the static plate 23 to fix the position of axially restrain the packages 10 forming the layer 30 when the pair of retractable plates 22 are retracted apart in the x-axis. The layer 30 thereby drops downwardly in the z-axis onto the pallet stack 35 when the retractable plates 22 are separated in this manner. One of the retractable plates 22 passes under the static plate 23 when the retractable plates are separated. The pallet 31 is then lowered in the z-axis and the retractable plates 22 are contracted together for receiving another layer 30 from the arranging station (first) conveyor 16. When the pallet stack 35 is completed, having the required number of layers 30, the pallet 31 can be transported to a truck using a forklift.

Hence, the transport of each package 10 in the package arranging system 8 can be characterised as follows. Each package 10 is initially positioned on the first transportation means and is transported along an input (second) path 39. The first pick-and-place robotic system then positions, when required, the packages 10 from a picking (third) position 40 on the input (second) path 39 to a placing (first) position 36 on an arranging (first) path 37. Each package 10 is subsequently transported by the first transportation means along the arranging (first) path 37 to a layer (second) position 38. The layer (second) position 38 forms a part of the predetermined configuration 26.

It will be appreciated that the positions 36, 38, 40 and paths 37, 39 for any given package 10 may or may not coincide with the respective positions 36, 38, 40 or paths 37, 39 of another package 10 either when forming the same layer 30 or a different layer 30.

It will be further appreciated that when the picking (third) 40 and placing (first) 36 positions coincide, the package 10 need not be positioned using the pick-and-place robotic system because the input (second) 39 and arranging (first) 37 paths intersect. Hence, positioning of the package 10 is not actually required when the y-axis coordinate of the package 10 at the picking (third) position 40 is the same as the y-axis coordinate of the package 10 at the placing (first) position 36, because the input (second) 39 and arranging (first) 37 paths of each package 10 are co-linear. In reality, however, each package 10 is positioned using the pick-and-place robotic system to ensure the position of each package 10.

According to a second example of the first embodiment, there is provided a method for forming a layer 30 as shown in FIG. 2. The completed layer 30 comprises five packages 10, labeled A to E respectively, which accumulate to occupy layer (second) positions 38, in that order. Packages A, B, D, and E are of a first size whereas package C is of a second size. FIG. 2 shows the transport of packages 10 on the arranging station (first) conveyor 16 at four successive moments in time (denoted as t=1, 2, 3 and 4 respectively).

At a first moment in time (i.e. t=1), packages A to E are being transported at an arranging (first) velocity V₁ on arranging station (first) conveyor 16. The respective input (second) paths 39 of packages A, B, D, and E coincide and are parallel to the input (second) path 39 of package C.

At a second moment in time (i.e. t=2) packages A and B have been positioned in respective placing (first) positions 36 by the first pick-and-place robotic system. It is apparent that there may be a plurality of possible placing (first) positions 36 for each package 10, each possible placing (first) position 36 having the same y-axis coordinate and a different x-axis coordinate. That is, the first pick-and-place robotic system can position a given package 10 at a number of possible placing (first) positions 36 along the x-axis. Package A has a picking (third) orientation Φ at a picking (third) position 40 of 900 relative to its corresponding placing (first) orientation whereas, in contrast, package B has the same orientation Φ at its picking (third) and placing (first) positions. Thus, the first pick-and-place robotic system picks each package 10 from an upstream position on the arranging station (first) conveyor 16 and places it, and optionally rotates it to a different placing (first) orientation, as the package 10 moves downstream on the arranging station (first) conveyor 16.

At a third moment in time (i.e. t=3) package C has not been positioned or oriented using the first pick-and-place robotic system. This is because the input (second) path 39 and arranging (first) path 37 of package C intersect where the picking (third) 40 and placing (first) 36 positions coincide. Package A now occupies its required layer (second) position 38 and package D occupies its picking (third) position 40 thereby triggering the first beam sensor 24.

At a fourth moment in time (i.e. t=4) packages A, B and C are in their respective layer (second) positions 38 and packages D and E have been positioned at respective placing (first) positions 36. The arranging (first) path 37 of package E is parallel to the arranging (first) path 37 of package B (as shown at t=2). A further group of packages A to E are successively transported on the arranging station (first) conveyor 16 to be positioned and oriented, when required, to form another layer 30. If required, further groups of packages 10 can be transported to form further layers 30.

At a moment of time beyond the fourth moment of time (not shown), when packages A to E are in their required layer (second) positions 38, the resulting layer 30 is transported to the pallet 31.

As demonstrated in the second example, respective packages 10 on the arranging station (first) conveyor 16 can have different picking (third) positions 40. Guiding means (not shown) are generally provided for aligning the packages 10 linearly, such that each package 10 has the same y-axis co-ordinate at a picking (third) position 40, because the first beam sensor 24 can only detect the x-axis position of each package 10 and not the y-axis position. However, when guiding means are not provided, the y-axis position of each package 10 may fluctuate when being transported from the metering (third) conveyor 12 to the arranging station (first) conveyor 16, and therefore a first gripper 20 which can position each package 10 in a known y-axis position would be advantageous. A first gripper 20 comprising two grasping members which can be contracted together to grasp a package 10 in the y-axis, can be used for this purpose.

According to the first example, however, the y-axis position is known and the x-axis position is determined using the first beam sensor 24, prior to moving a package 10 from a picking (third) position 40. After triggering the first beam sensor 24, the x-axis position can be more accurately monitored by moving the first gripper 20 so as to track the package 10 at the arranging (first) velocity V₁, until the package 10 is secured (i.e. picked). The first gripper 20 also orients the position of each package 10 into a known placing (first) orientation Φ.

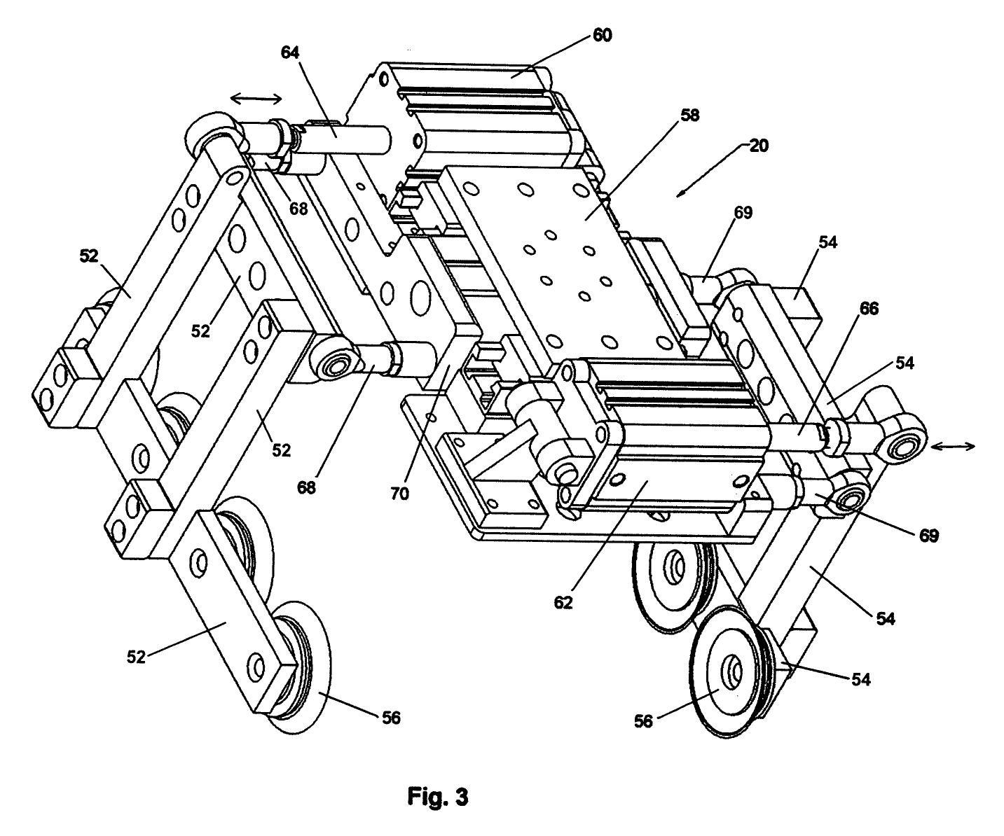

A first gripper 20 comprising a first grasping member and a second grasping member is shown in FIG. 3 and can be used for handling package sets 11 comprising at least one package 10. During picking, both grasping members are contracted together for grasping a package set 11 there between, such that the packages 10 constituting the package set 11 are thereby gripped in compression by the grasping members on opposing sides. The first grasping member comprises a first grasping arm 52 having four polyurethane cups 56 mounted at one end. Similarly, the second grasping member comprises a second grasping arm 54 also having four polyurethane cups 56 firmly fixed to one end. First 60 and second 62 pneumatic cylinders control the contraction of the first and second grasping members respectively.

During picking, the first gripper 20 is positioned so that the grasping members are contracted together along the x-axis. The polyurethane cups 56 are therefore pressed against opposite faces of a package set 11 being picked, thereby aligning the package set 11 to a known orientation Φ at a known x-axis coordinate within the first gripper's 20 grasp. Therefore, the position (x,y) and orientation Φ of the package set 11 in the grippers grasp is reliably known and, in turn, the position and orientation of the first gripper 20 with respect to the first robot 18 is also known. Hence, the packages 10 can be placed in their required placing (first) positions 36 with a positional accuracy of at least about ±15 mm and a placing orientation Φ (also referred to as a first orientation) accuracy of at least about ±2°.

A first drive shaft 64, coupled to the first grasping arm 52, is driven in and out of the first pneumatic cylinder along the x-axis during picking and placing operations respectively. A pair of first stabilizing shafts 68 are further coupled to the first grasping arm 52 and are constrained to freely move lineally along the x-axis by holes in a first stabilizing plate 70. Similarly, a second drive shaft 66, a pair of second stabilizing shafts 69 and a second stabilizing plate are provided to drive and stabilize the second grasping member during picking and placing. A mounting plate 58 is provided for mounting the first gripper 20 to the first robot 18.

A package set 11 is grasped during picking and is firmly gripped in position by the compression of the grasping members. Each grasping member cup 56 can be a vacuum cup, thereby further reducing the possibility of any packages slipping when being held in the first gripper's 20 grasp. Vacuum cups can have the drawback of causing packages to stick to the cups during release, thereby introducing positional errors. However, slippage is most likely to occur when sliding the package set 11 from a picking (third) position 40 to a placing (first) position 36. Grasping the package set 11 on two opposing faces is less likely to result in package slip than when gripping the package set 11 from above using a vacuum cup array gripper, particularly when sliding the packages 10 along the first transportation means.

The foregoing first gripper 20 provides a flexible alternative to industrial grippers currently used in the art whereby packages 10 of different sizes can be gripped, and centrally positioned within the gripper's grasp, without having to significantly reconfigure the gripper. That is, adjustments to the minimum separation distance between the grasping members may be required when reconfiguring the gripper to handle packages 10 of a significantly different size. The positioning of packages 10 in the grippers grasp is also less likely to vary over time, as a result of the wearing of mechanical components, because the packages 10 are gripped from opposite sides thereby causing substantially uniform wear on each side. Fixedly gripping the packages 10 also results in a more accurately known placing (first) package position 36 and orientation, and hence layer (second) position 38 and orientation, than “bumping” the package which introduces positional and rotational errors.

The foregoing first pick-and-place robotic system can be quite difficult to program, and re-program. That is, picking (third) 40 and placing (first) 36 positions must be individually programmed for each package 10 being handled, taking into account object size, thereby forming a sequence of programmed positions. Once the pick-and-place sequence has been programmed, the operator must then perform a trial run to ensure that the sequence is correct.. Undesirably, it is only during the trial run that an operator can determine whether the sequence of programmed positions 36,40 have been entered correctly. It can be quite difficult to amend either a particular position in the programmed sequence or the ordering of the sequence and hence the entire sequence is often, undesirably, re-programmed in its entirety when there are errors in the sequence.

Accordingly, a further aspect of the present invention provides simulation software for allowing a user to simulate the arranging of a plurality of packages 10 into a desirable configuration 26. A user determines and inputs the layer (second) positions 38 for each package 10 to a computer system which performs the simulation. The computer system comprises a display for displaying the simulated arrangement of packages 10 into the determined configuration 26 over time, as shown in FIG. 2 for example. The user can simply and quickly arrange the packages 10 into a desirable configuration 26 using a mouse to “drag-and-drop” each package 10 into a required layer (second) position 38 on the display.

The user effectively specifies the order (i.e. sequence) in which the packages 10 are to be assembled into the determined configuration 26 (e.g. A, B, C, D and then E in sequence) when sequentially positioning the packages 10 on the display. Once the layer (second) position 38 and corresponding layer (second) orientation Φ is inputted into the computer system for each package forming a layer 30, the configuration 26 and sequence order is determined. The direction of travel of the packages 10 is also inputted by the user and respective arranging (first) paths 37 for each package 10 are subsequently determined using the computer system. The placing (first) position 36 for each package 10 can then be determined, using the computer system, based upon a corresponding layer (second) position 38 and a corresponding arranging (first) path 37. A placing (first) orientation Φ for each package 10 at a corresponding placing (first) position 36 is also determined based on the corresponding layer (second) orientation Φ.

When the simulation is performed, packages 10 are initially shown on a display at respective placing (first) positions 36, in placing (first) orientations which, for the present example, are the same as layer (second) orientations. The transport of the packages 10 from the placing (first) positions 36 along corresponding arranging (first) paths 37 is then shown on the display. The restraint of the transport of the package sets 10 along the arranging (first) paths 37 so that the packages 10 accumulate at the layer (second) positions 38 is simulated over time. Hence, the simulation of packages 10 collectively being arranged into the predetermined configuration 26 is thereby performed.

This simulation method enables the user to perceive whether there is the potential for any interference between packages 10 as they accumulate to form the predetermined configuration 26, prior to programming the package arranging system and performing a trial run. The user can quickly alter the ordering in which the packages 10 accumulate to form the predetermined configuration 26 on the display, and then re-simulate to view the changed sequence in which the layer 30 is formed. Once satisfied with the manner in which the layer 30 will be assembled, the user can translate (i.e. program) simulation parameters used during the computer simulation to a controller for controlling the package arranging system 8. The simulation parameters translated would include the placing (first) positions 36 and corresponding placing (first) orientations for each respective package 10. The translated parameters would then be used to control the first pick-and-place robotic system.

Successive layers 30 used to form the pallet stack 35 would typically comprise a different configuration 26 of packages 10 to facilitate with the interlocking of packages 10 forming adjacent layers 30. For example, a first configuration 26 can be mirrored, in the y-axis, with respect to a successive second configuration 26 formed. Alternatively, the configurations 26 of successive layers can be the same, however, a first configuration 26 can be rotated by 90° or 180° relative to a successive second configuration 26 formed. Simulation parameters are therefore translated to the controller along with information indicating which layer 30 in the pallet stack 35 they relate.

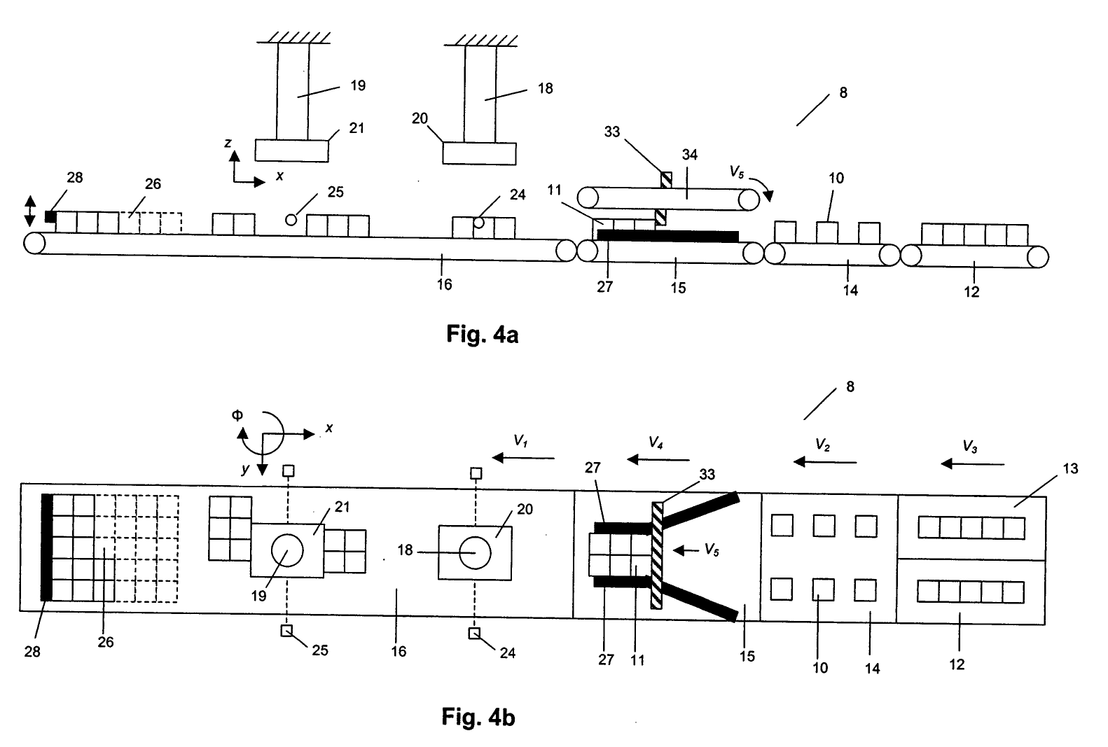

According to a second embodiment of the present invention, there is provided a package arranging system 8 for arranging a plurality of package sets 11 into a predetermined configuration 26 as shown in FIG. 4. Whereas the first embodiment involved the handling of package sets 11 comprising one rectangular package only, the present embodiment involves handling package sets 11 comprising six square packages 10.

The package arranging system 8 comprises two metering stations where individual packages 10 are inputted to the system, a separating station for separating adjacent packages 10 forming a package set 11, a grouping station for reducing any separation between adjacent packages forming the package set 11, and an arranging station for arranging the package sets 11 into the predetermined configuration 26. Accordingly, a first metering (third) conveyor 12 and second metering conveyor 13 (also referred to as the fifth conveyor 13) provide packages 10 to a first transportation means which comprises a separating station (second) conveyor 14, a grouping station conveyor 15 (also referred to as the fourth conveyor 15) and an arranging station (first) conveyor 16.

A detailed description of the package arranging system 8 shown in FIG. 4 is provided below.

The packages 10 are input into the package arranging system 8 on two metering conveyors 12, 13. That is, a first metering (third) conveyor 12 and second metering (fifth) conveyor 13 are aligned side-by-side. Packages 10 on the first metering (third) conveyor 12 are transported in parallel with the packages 10 on the second metering (fifth) conveyor 13. The packages on both metering conveyors 12, 13 are transported at a metering (third) velocity V₃ of between 12 to 18 metres per minute (m/min).

Packages are transferred from the metering conveyors 12, 13 to the separating station (second) conveyor 14 which acts as an acceleration conveyor. The separating station (second) conveyor 14 transports the packages 10 at a separating (second) velocity V₂ of 50 m/min wherein the separating (second) velocity V₂ is greater than the metering (third) velocity V₃. Adjacent packages 10 along the x-axis are therefore further separated from one another when transferred from a respective metering conveyor 12, 13 to the separating station (second) conveyor 14. The position of each package set 11 can be defined as the centroid, in the xy-plane, of its component packages 10.

The separated packages 10 are subsequently transferred from the separating station (second) conveyor 14 to the grouping station (fourth) conveyor 15. The grouping station reduces any separation, in the x and y axes, between adjacent packages forming a package set 11 being transported along an input (second) path 39. The grouping station comprises a second flight bar system which, in turn, comprises two flight bars 33 attached to a second flight bar conveyor 34. In reality, there could be many more flight bars 33 attached to the second flight bar conveyor 34, depending upon various factors including: the number of packages 10 in the package sets 11; the size of the packages 10 and package sets 11; the length of the grouping station (fourth) conveyor 15; and the velocity of the grouping station (fourth) conveyor 15. The grouping station also comprises a pair of guide rails 27 for guiding the packages 10 being transported. The guide rails 27 are adjusted to a suitable separation distance for receiving packages 10 prior to use, and are fixedly held in position when in use.

In use, a grouping station flight bar 33 travels axially to the direction of transport of the package sets 11 (i.e. parallel to the x-axis). The flight bars 33 operate at a different height (i.e. z-axis position) to the guide rails 27 so as to prevent any interference in the xy-plane. The guide rails 27 have a tapered portion which guide the packages 10 being transported toward the centre of the grouping station (fourth) conveyor 15. The packages 10 slide along the guide rails 27 and any separation between adjacent packages 10 is thereby reduced in the y-axis using a funneling-type operation. The guide rails 27 also have a portion which is parallel to the x-axis and situates each package set 11 at a known y-axis location (i.e. the centre) on the grouping station (fourth) conveyor 15.

The grouping station (fourth) conveyor 15 transports a package set 11 at a grouping (fourth) velocity V₄ of 40 m/min along a corresponding input (second) path 39 after being transferred from the separating station (second) conveyor 14. Hence, the grouping (fourth) velocity V₄ is less than the separating (second) velocity V₂. During the grouping of the packages 10 into the package set 11, the flight bar 33 moves at a flight bar (fifth) velocity of 50 m/min along the input (second) path 39 of the package set 10. The flight bar (fifth) velocity is greater than the grouping (fourth) velocity V₄, which ultimately causes respective packages 10 of the package set 11 to accumulate on the grouping station (fourth) conveyor 15 adjacent to the flight bar 33. In this manner, any separation between adjacent packages 10 along the x-axis in the package set 11 are reduced. Each package 10 abuts any adjacent packages 10 of the package set 11 along the x-axis.

In summary, any separation between adjacent-packages 10 in the y-axis of the package set 11 is reduced using the guide rails 27 and any separation between adjacent packages 10 in the x-axis of the package set 11 is reduced using the flight bar 33. Therefore, subsequent-to grouping, any given package 10 in a package set 11 abuts any adjacent packages 10 in both the x and y axes. The grouping of packages 10 in a package set 11 can be performed one axis at a time or in both axes concurrently.

The package sets 11 are transferred from the grouping station (fourth) conveyor 15 to an arranging station (first) conveyor 16 by the second flight bar system. Each flight bar 33 pushes a package set 11 over the grouping station (fourth) conveyor 15, at the flight bar (fifth) velocity, and onto the arranging station (first) conveyor 16 where the package sets 11 are subsequently transported at an arranging (first) velocity V₁ of 50 m/min. Hence, the arranging (first) velocity V₁ is comparable to the flight bar (fifth) velocity and minimal separation is introduced, in the x-axis, between adjacent packages 10 in each package set 11 during transferal.

The positioning means comprises a first pick-and-place robotic system and a second pick-and-place robotic system. The first pick-and-place robotic system comprises a first robot 18 coupled to a first gripper 20. The second pick-and-place robotic system comprises a second robot 19 coupled to a second gripper 21. The package sets 11 are transported on the first transport means in succession, one at a time. A first beam sensor 24 and a second beam sensor 25 are located at different x-axis positions along the arranging station (first) conveyor 16, beneath the first and second pick-and-place robotic systems respectively.

Each beam sensor 24, 25 detects each package set 11 being transported on the arranging station (first) conveyor 16, however, only triggers a respective pick-and-place robotic system upon the detection of every alternate package set 11. That is, the first pick-and-place robotic system positions first package sets 11 and the second pick-and-place system positions second package sets 11, where first and second package sets 11 are alternating package sets 11 being transported, in succession, on the arranging station (first) conveyor 16. Using two cooperating pick-and-place robotic systems in this manner enables the conveyor 12, 13, 14, 15, 16 velocities to be increased, therefore increasing the speed at which the layer 30 is assembled. After positioning the package sets 11 in their placing (first) positions 36, the package sets 11 are transported to their corresponding layer (second) positions 38.

Additional variations and embodiments of the present invention will be apparent to a person skilled in the art.

According to the first embodiment described, a first beam sensor 24 was used to determine the x-axis position of each package 10 before picking. Alternatively, a vision system can be used to identify the xy-axes position of each package 10 on the arranging station (first) conveyor 16 and therefore the package sets 11 need not be transferred to the arranging station (first) conveyor 16 linearly. The vision system is also able to identify the size and shape of each package 10.

According to the first embodiment, the packages 10 were separated along the x-axis by a fixed distance, prior to sensing using the first beam sensor 24. Although desirable, carefully controlled fixed spacing is not required, and the packages 10 do not need to be evenly spaced. Instead, separating adjacent packages 10 by at least a minimum distance will minimise the possibility of packages 10 colliding during positioning.

According to the first embodiment, each picking (third) position 40 was detected using the first beam sensor 24, however, such sensing is not required when each picking (third) position 40 is predetermined based on time wherein packages are presented to their picking (third) positions 40 at known times.

The first and second grippers 20 shown in FIG. 3 comprise first and second grasping members for gripping and aligning package sets 11 in one axis. In an alternative embodiment, the grippers similarly also comprise third and fourth grasping members for gripping and aligning package sets 11 in a second axis. Such a gripper would thereby accurately position the package sets within the grippers grasp in the xy-plane (i.e. in both x and y axes).

The first gripper of the first embodiment was used to hold package sets 11 in compression between the first and second grasping members. Each grasping member comprised cups 56, which were vacuum cups for improved gripping. In an alternative embodiment, the vacuum cups could be solely relied upon for gripping the sides of packages 10, instead of also gripping the packages in compression. That is, the packages 10 are not held in compression and there may be gaps between adjacent packages being gripped.

In a further embodiment of the present invention, a bar code scanner could be used for reading bar codes on each package 10 travelling along a second path. The type of package 10 could therefore be identified prior to positioning.

According to the embodiments described, the first transportation means comprised a plurality of belt conveyors. Alternative conveyors such as roller conveyors or inclined chutes can also be used. In the second embodiment, the first transportation-means comprises a separating station (second) 14, grouping station (fourth) 15, and arranging station (first) conveyor. In an alternative embodiment, these belt conveyors can be replaced by a single conveyor travelling at a constant velocity. The axial (first) flight bar 32 can be replaced by a moveable (in the z-axis) barrier 28 for reducing any separation between adjacent packages along the x-axis.

According to a further embodiment of the present invention, the positioning means comprises a gantry robot.

According to an alternative embodiment of the present invention, the position of each package set 11 is based upon a corner, rather than the centroid, of the package set 11. In another embodiment, the reference point for defining a first package position (e.g. corner or edge) is different to a reference point for defining a second package position (e.g. centroid).

The input (second) 39 and arranging (first) 37 paths described in the preferred embodiments were linear owing to the linear arrangement and nature of the conveyors. According to an alternative embodiment, these paths 37, 39 are curvilinear whereby the conveyors curve in the xy-plane accordingly.

The first embodiment described the arranging of a layer 30 of packages 10 wherein each package was rectangular. It is preferred and not essential, that the packages 10 are substantially box-shaped.

The method of simulation described in the preferred embodiment involved the inputting of many parameters by a user. In an alternative embodiment, various simulation parameters are stored on disk. In yet another alternative embodiment, the user need only input the size of a single package 10, and the simulation software then automatically determines the arrangement of the packages 10 to form the layer 30, depending upon the size of the pallet 31. The package ordering, placing (first) and layer (second) positions, placing (first) and layer (second) orientations, and arranging (first) paths are automatically determined by the computer system performing the simulation to yield a valid layer configuration.

The foregoing simulation method was described for the first embodiment only, where only a first robotic system was used. In an alternative embodiment, the simulation method can be used to simulate layer formation using the two co-operating robotic systems described in the second embodiment. In addition, the simulation method could be used to simulate the arranging of package sets 11 comprising more than one package 10.

These and other modifications may be made without departing from the ambit of the invention, the nature of which is to be determined from the foregoing description.

1. A package arranging system for arranging a plurality of package sets into a predetermined configuration comprising:
positioning means for, when required, fixedly gripping respective ones of said package sets and subsequently positioning said package sets at respective ones of a plurality of first positions and first orientations on a first transportation means;
said first transportation means for transporting said package sets from said first positions toward corresponding ones of a plurality of second positions along a plurality of first paths; and
restraining means for restraining the transport of said package sets along said first paths so that said package sets accumulate on said first transportation means at said second positions, said package sets thereby being collectively arranged into said predetermined configuration when said package sets are in said second positions.

2. A system as claimed in claim 1, wherein said positioning means comprises a cantilever arm robot and a gripper, said positioning means, in use, operating as a pick-and-place robotic system.

3. A system as claimed in claim 1, wherein each package set has a second orientation when positioned at a corresponding second position, each respective first orientation being based on a corresponding said second orientation.

4. A system as claimed in claim 1 wherein, when required, said package sets are fixedly gripped at respective ones of a plurality of third positions on respective ones of a plurality of second paths on said first transportation means and subsequently positioned by sliding said package sets on said first transportation means to corresponding ones of said first positions.

5. A system as claimed in claim 1, wherein said first transportation means comprises at least one conveyor.

6. A system as claimed in claim 1, wherein said positioning means comprises a first robot coupled to a first gripper for fixedly gripping said first package sets during positioning.

7. A system as claimed in claim 6, wherein said positioning means further comprises a second robot coupled to a second gripper for fixedly gripping second package sets during positioning, said first and second package sets being alternating ones of said package sets being successively transported along respective ones of said first paths.

8. A system as claimed in claim 6, wherein said positioning means can position said package sets in said first positions with a positional accuracy of less than about ±15 mm.

9. A system as claimed in claim 6, wherein said first gripper comprises a first grasping member and a second grasping member, both grasping members, in use, being contracted together for grasping a package set on opposing sides, said package set thereby being gripped in compression by said grasping members.

10. A system as claimed in claim 9, wherein said grasping members each comprise a plurality of cups.

11. A system as claimed in claim 10, wherein each cup is a vacuum cup.

12. A system as claimed in claim 1, wherein said first paths are linear.

13. A system as claimed in claim 1, wherein said first paths are curvilinear.

14. A system as claimed in claim 1, wherein said first paths are parallel.

15. A system as claimed in claim 1, wherein a first package set is of a first size and a second package set is of a second size.

16. A system as claimed in claim 4, wherein each package set is a singleton set comprising one package only.

17. A system as claimed in claim 16, further comprising a separating station for increasing the separation between consecutive ones of said package sets being transported along respective ones of said second paths.

18. A system as claimed in claim 17, wherein said separating station comprises a second conveyor transporting said package sets at a second velocity.

19. A system as claimed in claim 18, further comprising a third conveyor transporting said package sets at a third velocity, said second velocity being greater than said third velocity such that consecutive ones of said package sets are further separated when package sets being transported on said third conveyor are transferred to said second conveyor.

20. A system as claimed in claim 4, wherein a package set comprises at least two packages.

21. A system as claimed in claim 20, further comprising a grouping station for reducing any separation, in at least one axis, between adjacent packages forming said package set being transported along a second path.

22. A system as claimed in claim 21, wherein said grouping station comprises:
a fourth conveyor for transporting said package set at a fourth velocity along said second path; and
a flight bar for moving at a fifth velocity along said second path of said package set, said fifth velocity being greater than said fourth velocity;
wherein, in use, respective packages of said package set thereby accumulate on said fourth conveyor adjacent said flight bar and any separation between adjacent ones of said at least two packages in a first axis is reduced.

23. A system as claimed in claim 21, wherein said grouping station comprises:
a fourth conveyor for transporting said package set at a fourth velocity along said second path; and
a pair of guide rails for guiding said at least two packages as said package set is transported along said second path, thereby reducing any separation between adjacent ones of said package set in a second axis.

24. A system as claimed in claim 1, wherein said predetermined configuration of packages, once formed, is a layer of packages for a pallet.

25. A system as claimed in claim 24, further comprising a second transportation means for transporting said layer from said first transportation means to said pallet.

26. A system as claimed in claim 25, wherein said second transportation means comprises:
a static plate for initially receiving said layer from said transportation means;
a flight bar for pushing said layer from said first transportation means, over said static plate, and onto a pair of adjacent retractable plates;
a receiving means which receives said layer being pushed by said flight bar; and
said retractable plates which, when retracted from one another, allow said layer to drop onto said pallet;
wherein said receiving means and said static plate combine to restrain packages forming said layer when said retractable plates are retracted from one another.

27. A simulation method for allowing a user to simulate the arranging of a plurality of package sets into a predetermined configuration, said method comprising the steps of:
simulating the positioning of said package sets at respective ones of a plurality of first positions;
simulating the transport of said package sets from said first positions toward corresponding ones of a plurality of second positions along a plurality of first paths; and
simulating the restraint of the transport of said package sets along said first paths so that said package sets accumulate at said second positions, said package sets thereby being collectively arranged into said predetermined configuration when said package sets are in respective ones of a plurality of second positions.

28. A method claimed in claim 27, wherein said second positions of each respective package set are input by said user to a computer system performing said simulation.

29. A method as claimed in claim 28, wherein each first position is determined based on a corresponding second position and a corresponding first path.

30. A method as claimed in claim 29, wherein said determined first positions can be translated to a controller for controlling a package arranging system.

31. A method as claimed in claim 28, wherein a second orientation for each respective package set at a corresponding second position is also input by said user.

32. A method as claimed in claim 31, wherein a first orientation for each respective package set at a corresponding first position is determined based on each corresponding second orientation.

33. A method as claimed in claim 32, wherein said determined first orientations can be translated to a controller for controlling a package arranging system.

34. A method as claimed in claim 27, wherein each respective first path is determined based upon input by said user to a computer system performing said simulation.

35. A method for arranging a plurality of package sets into a predetermined configuration comprising the steps of:
when required, fixedly gripping respective ones of said package sets and subsequently positioning said package sets at respective ones of a plurality of first positions and first orientations on a first transportation means;
transporting said package sets by said first transportation means from said first positions toward corresponding ones of a plurality of second positions along a plurality of first paths; and
restraining the transport of said package sets along said first paths so that said package sets accumulate on said first transportation means at said second positions, said package sets thereby being collectively arranged into said predetermined configuration when said package sets are in said second positions.

36. A method as claimed in claim 35, wherein said package sets are gripped by a gripper coupled to a cantilever arm robot, said gripper and cantilever arm robot combining to position said package sets in said first positions with a positional accuracy of less than about ±15 mm.

37. A method as claimed in claim 35 wherein, when required, said package sets are fixedly gripped at respective ones of a plurality of third positions on respective ones of a plurality of second paths on said first transportation means and subsequently positioned by sliding said package sets on said first transportation means to corresponding ones of said first positions.

38. A method as claimed in claim 37, wherein each third position is predetermined based on time.

39. A method as claimed in claim 37, wherein each third position is detected using a sensor.

40. A method as claimed in claim 37, wherein each second path is predetermined.

41. A method as claimed in claim 37, further comprising the step of increasing the separation between consecutive ones of said package sets being transported along respective ones of said second paths.

42. A method as claimed in claim 37, further comprising the step of reducing any separation, in at least one axis, between adjacent packages forming a package set being transported along a second path.

43. A method as claimed in claim 42, wherein any separation between adjacent packages along said second path is reduced.

44. A method as claimed in claim 42, wherein any separation between adjacent packages normal to said second path is reduced.

45. A method as claimed in claim 42, wherein prior to said step of reducing any separation between adjacent packages forming a package set, said package set is formed when packages are provided to said first transport means by at least one conveyor.

46. A method as claimed in claim 35, further comprising the step of transporting said predetermined configuration of package sets, once formed, from said first transportation means to a pallet.

47. A method as claimed in claim 35 further comprising, prior to arranging said plurality of package sets into said predetermined configuration, the steps of:
computer simulating the arrangement of said plurality of packages into said predetermined configuration using a package arranging system; and
translating simulation parameters used during said computer simulation to a controller for controlling said package arranging system.

48. A method as claimed in claim 47, wherein said simulation parameters translated include said first positions and first orientations for each respective package set at a corresponding first position.

49. A method as claimed in claim 35, wherein said package sets are gripped by a gripper coupled to a cantilever arm robot, said gripper and cantilever arm robot combining to position said package sets in said first positions with an orientation accuracy of less than about ±2°.
